(19) United States
(12) Patent Application Publication
(10) Pub. No.: US 2026/0188135 A1
(43) Pub. Date: Jul. 2, 2026

(54) AI-BASED INTERACTIVE STORY MACHINE FOR CHILDREN

(71) Applicant: chechirp LLC, Dover, DE (US)

(72) Inventor: Yujia XIE, Shenzhen (CN)

(73) Assignee: chechirp LLC, Dover, DE (US)

(21) Appl. No.: 19/001,614

(22) Filed: Dec. 26, 2024

(51) Int. Cl. G09B 7/02; G10L 15/18; G10L 15/22; H04W 4/80

(52) U.S. Cl. CPC G09B 7/02; G10L 15/18; G10L 15/22; H04W 4/80

(57) ABSTRACT

The present invention relates to the technical field of electronic products, and discloses an AI-based interactive story machine for children. The AI-based interactive story machine for children includes a story machine body and an AI control system; the story machine body includes a front housing, a rear housing, a display screen, a loudspeaker, a microphone, a voice button and an NFC story card; the front housing and the rear housing are connected through a buckle; the display screen is installed in the middle of a side surface of the front housing; the loudspeaker and the microphone which are located below the display screen are installed on the side surface of the front housing; and the voice button is installed on an edge of the side surface of the front housing.

### FIELD OF THE INVENTION

The present invention relates to the technical field of electronic products, and particularly relates to an AI-based interactive story machine for children.

### BACKGROUND OF THE INVENTION

As an electronic product designed for children, story machines play an important role in the growth process of the children, they usually take a rich variety of story resources as the core, aiming to promote the language development, imagination cultivation and cognitive ability improvement of the children through storytelling. The main function of early story machines is relatively simple, only to simply play a pre-recorded story audio, the children can only passively receive information, and it is lack of interactivity. With the continuous progress of science and technology, some story machines are provided with simple interactive functions, for example, pressing specific buttons to play different stories, and adjusting the volume, but these interactions are still relatively limited and cannot deeply meet the diverse needs of the children in the process of learning and entertainment.

The modern education concept focuses on the active participation and personalized experience of children in the learning process. However, the story machines in related technology is relatively fixed in the story content, cannot be flexibly adjusted according to the interests and learning progress of the children, and is lack of the interactive link depth, and difficult to stimulate the thinking ability and creativity of the children.

In order to solve the above problems, the present application provides an AI-based interactive story machine for children.

### SUMMARY OF THE INVENTION

Based on the technical problems in the Background Art, the present invention provides an AI-based interactive story machine for children.

The present invention provides an AI-based interactive story machine for children, comprising a story machine body and an AI control system,
the story machine body comprises a front housing, a rear housing, a display screen, a loudspeaker, a microphone, a voice button and an NFC story card;
the front housing and the rear housing are connected through a buckle; the display screen is installed in the middle of a side surface of the front housing; the loudspeaker and the microphone which are located below the display screen are installed on the side surface of the front housing; the voice button is installed on an edge of the side surface of the front housing; an inserting opening is formed between top surfaces of the front housing and the rear housing, and the NFC story card is inserted into the inserting opening; batteries are installed in the front housing and the rear housing; and
the AI control system is configured to implement intelligent interaction and personalized experience of the story machine body.

As a further scheme of the present invention, the AI control system comprises:
a story storage module which is configured to store massive story resources;
an NFC identification module which is responsible for identifying the NFC story card and reading story information in the card and performing related interaction settings, and performing data interaction with the NFC story card through a near-field communication technology;
a display driving module which is configured to drive the display screen to work to display images and text prompts in a story and related information of an interaction link to the children in a visual mode, receive display instructions from other modules, and convert the display instructions into a signal format that can be identified by the display screen;
an audio output module which is connected to the loudspeaker, and is configured to output audio contents of the story and voice prompts and sound effects in the interaction process, so as to provide auditory experience for the children;
a voice input module which is connected to the microphone, and is configured to collect voice answers of the children, and convert the voice answers into digital signals to facilitate subsequent voice identification and processing;
an AI processing module which is responsible for identifying, understanding and analyzing the voice inputted by the children, judging whether the answers of the children are correct or not by a natural language processing algorithm and a machine learning model, and determining the story scenario trends according to an answer result;
an interaction control module which is configured to coordinate interaction work among all the modules of the story machine, manage the story playing process, control the question-and-answer link, and carry out data transmission among the modules; and
a power management module which is configured to manage built-in batteries, comprising battery power monitoring, charging control and stable power supply for other modules;
the story storage module, the NFC identification module, the display driving module, the audio output module, the voice input module, the AI processing module and the interaction control module are all connected to the power management module to obtain power support from the power management module; the NFC identification module is connected to the story storage module so that the read NFC card information can be transmitted to the story storage module to call the story content; the voice input module is connected to the AI processing module so as to transmit the collected voice signals to the AI processing module for analyzing; the AI processing module is connected to the story storage module, the display driving module and the interaction control module to realize story plot selection, image display control and interaction coordination with other modules; the interaction control module is connected to the audio output module and controls the output of story audio and prompt sound effect; and the display driving module is connected to the display screen.

As a further scheme of the present invention, the story storage module comprises:
a storage unit which adopts a built-in mass storage as a physical storage medium, and is responsible for actually storing massive story resources, comprising various types of story data such as fairy tales, fables and science stories, and storing the story data in a digital coding form to provide a data basis for story calling;
an index unit which is configured to establish an index system for the story resources to facilitate quick positioning and retrieval of specific story contents; and
an updating unit which is configured to connect an external data source to realize updating and expansion of the story resources.

As a further scheme of the present invention, the NFC identification module comprises:
a signal sensing unit which is internally provided with an NFC antenna and a related sensing circuit, and is configured to sense a near-field communication signal transmitted by the NFC story card when the NFC story card approaches, start an identification process, ensure that communication connection is established with the NFC story card and make preparations for data reading;
a data reading unit which is configured to read story information and related interactive setting data from the NFC story card through an NFC communication protocol; and
a compatibility unit which is responsible for ensuring that the NFC identification module is compatible with the NFC story cards with different standards and formats.

As a further scheme of the present invention, the display driving module comprises:
an image conversion unit which is configured to receive image data from other modules, and convert the image data into a format that can be directly identified and displayed by the display screen;
a text rendering unit which is responsible for typesetting and rendering the text prompts and dialogue text information in the story according to characteristics of the display screen; and
an instruction analysis unit which is configured to analyze the display instructions from the interaction control module, and determine the type, display position and display duration parameter of the content to be displayed.

As a further scheme of the present invention, the audio output module comprises:
a signal amplification unit which is connected to the loudspeaker, and is configured to receive audio signals from the story storage module or other modules, and carry out power amplification on the audio signals so as to drive the loudspeaker to generate sound with enough volume, thereby ensuring that the children can clearly hear story contents and sound prompts within a normal use distance, and adapting to volume requirements of different environments;
a sound effect processing unit which is responsible for carrying out sound effect processing on the audio signals; and
an audio mixing unit which is configured to mix the audio signals according to a certain proportion and rule in a case of a plurality of audio sources.

As a further scheme of the present invention, the voice input module comprises:
a voice collection unit which is connected to the microphone and is configured to carry out preliminary collection on the sound signals received by the microphone;
a signal preprocessing unit which is configured to carry out preprocessing operations comprising noise reduction processing on the collected voice signals, remove environmental background noise by a digital signal processing algorithm, and improve the signal-to-noise ratio of the voice signals; and
an analog-to-digital conversion unit which is configured to convert the preprocessed analog voice signals into digital signals so as to carry out transmission and processing in a digital system.

As a further scheme of the present invention, the AI processing module comprises:
a voice identification unit which is configured to identify the digital voice signals transmitted by the voice input module by voice identification algorithm, and convert voice contents into a text form;
a semantic understanding unit which is configured to carry out semantic understanding on the text outputted by the voice identification unit based on a natural language processing technology; and
a learning and decision-making unit which is configured to carry out learning and analysis on behavior patterns of the children by a machine learning model according to use habits and interactive performance of the children.

As a further scheme of the present invention, the interaction control module comprises:
a process management unit which is responsible for managing the whole use process of the story machine body, ensuring that the whole process is orderly carried out according to a predetermined logic from the selection and playing process of the story to the insertion and ending of an interactive link, and providing smooth use experience for the children;
a data coordination unit which is configured to coordinate data transmission and sharing among all the modules; and
an event triggering unit which is configured to monitor events that the NFC story card is inserted, the voice button is pressed and the story is played to a specific part in the use process of the story machine body, and trigger the operation of the corresponding module according to the type of the events.

As a further scheme of the present invention, the power management module comprises:
an electric quantity monitoring unit which is configured to monitor the electric quantity level of the built-in batteries in real time, accurately calculate the percentage of the remaining electric quantity of the batteries by measuring voltage and current parameters of the batteries and applying an electric quantity calculation algorithm, and feed back electric quantity information to other modules, so that a user knows the electric power condition of the story machine body and charges in time;
a charging control unit which is responsible for managing the charging process when the story machine body is connected to an external power supply for charging; and
a power distribution unit which is configured to reasonably distribute the electric power outputted by the batteries according to the electric power requirements of all the modules of the story machine body.

The technical solution of the present invention has the following beneficial technical effects:
1. Through question-and-answer link and AI intelligent judgment, the children can actively participate in the development of a story, so that the interactivity can be greatly enhanced; and at a key plot of the story, different answers of the children will lead to different story endings, which makes the children feel own influence on the story, and stimulates the enthusiasm and initiative of the children to participate in;
2. The AI processing module is capable of carrying out personalized adjustment on the story recommendation and plot trends according to the voice input and interaction performance of the children, and it can provide more challenging stories and questions for the children with high language competence, and provide simpler and more vivid content for young children or children with low language competence, thus meeting the requirements of different children;
3. The questions in the question-and-answer link can be designed around knowledge points in the story, such as the relationship between characters in the story and the scientific principle, so that in the process of answering the questions, the children cannot only deepen their understanding of the content of the story, but also expand their knowledge and improve their cognitive ability;
4. Because the answers of the children will affect the plots of the story, the children are promoted to think before answering the questions, which develops the logical thinking, creativity and problem-solving skills of the children; and in some open-ended questions, the children need to give play to imagination to conceive the answers, thus exercising their innovative thinking; and
5. The information of interaction performance and learning progress of the children recorded by the system can provide parents with a basis for knowing the learning and thinking development of the children, and help the parents to carry out targeted education guidance.

### BRIEF DESCRIPTION OF THE DRAWINGS

FIG. 1 is a structural schematic diagram of an AI-based interactive story machine for children provided by the present invention.

FIG. 2 is a three-dimensional structural schematic diagram in FIG. 1 according to the present invention.

FIG. 3 is a system diagram of an AI-based interactive story machine for children provided by the present invention.

Reference numerals: 1, story machine body; 11, front housing; 12, rear housing; 13, display screen; 14, loudspeaker; 15, microphone; 16, voice button; and 17, NFC story card.

### DETAILED DESCRIPTION OF SOME EMBODIMENTS

In order to make the purpose, technical solution and advantages of the present invention more clear, the present invention is further described in detail below in conjunction with the specific embodiment and with reference to the accompanying drawings. It is to be understood that these descriptions are illustrative only and are not intended to limit the scope of the present invention. In addition, in the following instructions, descriptions of well-known structures and techniques are omitted to avoid unnecessary confusion of the concept of the present invention.

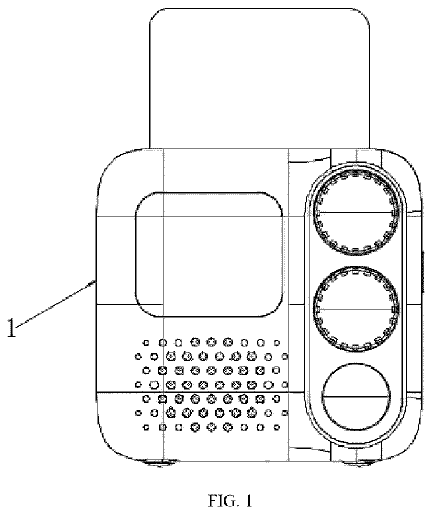

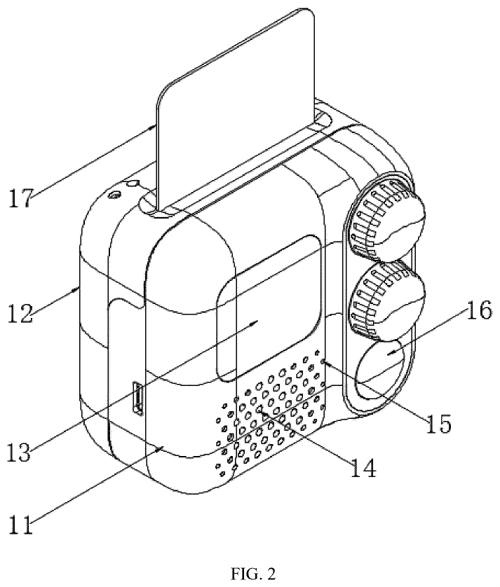

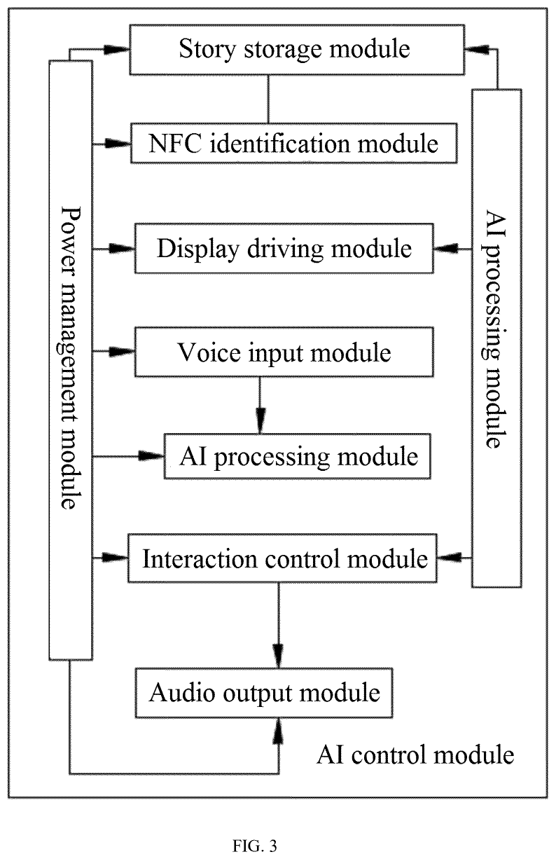

As shown in FIG. 1 to FIG. 3, the present invention provides an AI-based interactive story machine for children, which includes a story machine body 1 and an AI control system;
the story machine body 1 includes a front housing 11, a rear housing 12, a display screen 13, a loudspeaker 14, a microphone 15, a voice button 16 and an NFC story card 17;
the front housing 11 and the rear housing 12 are connected through a buckle; the display screen 13 is installed in the middle of a side surface of the front housing 11; the loudspeaker 14 and the microphone 15 which are located below the display screen 13 are installed on the side surface of the front housing 11; the voice button 16 is installed on an edge of the side surface of the front housing 11; an inserting opening is formed between top surfaces of the front housing 11 and the rear housing 12, and the NFC story card 17 is inserted into the inserting opening; batteries are installed in the front housing 11 and the rear housing 12; and
the AI control system is configured to implement intelligent interaction and personalized experience of the story machine body 1.

In this example, the AI control system comprises:
a story storage module which is configured to store massive story resources;
an NFC identification module which is responsible for identifying the NFC story card 17 and reading story information in the card and performing related interaction settings, and performing data interaction with the NFC story card 17 through a near-field communication technology;
a display driving module which is configured to drive the display screen 13 to work to display images and text prompts in a story and related information of an interaction link to the children in a visual mode, receive display instructions from other modules, and convert the display instructions into a signal format that can be identified by the display screen 13;
an audio output module which is connected to the loudspeaker 14, and is configured to output audio contents of the story and voice prompts and sound effects in the interaction process, so as to provide auditory experience for the children;
a voice input module which is connected to the microphone 15, and is configured to collect voice answers of the children, and convert the voice answers into digital signals to facilitate subsequent voice identification and processing;
an AI processing module which is responsible for identifying, understanding and analyzing the voice inputted by the children, judging whether the answers of the children are correct or not by a natural language processing algorithm and a machine learning model, and determining the story scenario trends according to an answer result;
an interaction control module which is configured to coordinate interaction work among all the modules of the story machine, manage the story playing process, control the question-and-answer link, and carry out data transmission among the modules; and
a power management module which is configured to manage built-in batteries, comprising battery power monitoring, charging control and stable power supply for other modules;
the story storage module, the NFC identification module, the display driving module, the audio output module, the voice input module, the AI processing module and the interaction control module are all connected to the power management module to obtain power support from the power management module; the NFC identification module is connected to the story storage module so that the read NFC card information can be transmitted to the story storage module to call the story content; the voice input module is connected to the AI processing module so as to transmit the collected voice signals to the AI processing module for analyzing; the AI processing module is connected to the story storage module, the display driving module and the interaction control module to realize story plot selection, image display control and interaction coordination with other modules; the interaction control module is connected to the audio output module and controls the output of story audio and prompt sound effect; and the display driving module is connected to the display screen 13.

In this example, the story storage module comprises:
a storage unit which adopts a built-in mass storage as a physical storage medium, and is responsible for actually storing massive story resources, comprising various types of story data such as fairy tales, fables and science stories, and storing the story data in a digital coding form to provide a data basis for story calling;
an index unit which is configured to establish an index system for the story resources to facilitate quick positioning and retrieval of specific story contents; and
an updating unit which is configured to connect an external data source to realize updating and expansion of the story resources.

In this example, the NFC identification module comprises:
a signal sensing unit which is internally provided with an NFC antenna and a related sensing circuit, and is configured to sense a near-field communication signal transmitted by the NFC story card 17 when the NFC story card 17 approaches, start an identification process, ensure that communication connection is established with the NFC story card 17 and make preparations for data reading;
a data reading unit which is configured to read story information and related interactive setting data from the NFC story card 17 through an NFC communication protocol; and
a compatibility unit which is responsible for ensuring that the NFC identification module is compatible with the NFC story cards 17 with different standards and formats.

In this example, the display driving module comprises:
an image conversion unit which is configured to receive image data from other modules, and convert the image data into a format that can be directly identified and displayed by the display screen 13;
a text rendering unit which is responsible for typesetting and rendering the text prompts and dialogue text information in the story according to characteristics of the display screen; and
an instruction analysis unit which is configured to analyze the display instructions from the interaction control module, and determine the type, display position and display duration parameter of the content to be displayed.

In this example, the audio output module comprises:
a signal amplification unit which is connected to the loudspeaker 14, and is configured to receive audio signals from the story storage module or other modules, and carry out power amplification on the audio signals so as to drive the loudspeaker 14 to generate sound with enough volume, thereby ensuring that the children can clearly hear story contents and sound prompts within a normal use distance, and adapting to volume requirements of different environments;
a sound effect processing unit which is responsible for carrying out sound effect processing on the audio signals; and
an audio mixing unit which is configured to mix the audio signals according to a certain proportion and rule in a case of a plurality of audio sources.

In this example, the voice input module comprises:
a voice collection unit which is connected to the microphone 15 and is configured to carry out preliminary collection on the sound signals received by the microphone 15;
a signal preprocessing unit which is configured to carry out preprocessing operations comprising noise reduction processing on the collected voice signals, remove environmental background noise by a digital signal processing algorithm, and improve the signal-to-noise ratio of the voice signals; and
an analog-to-digital conversion unit which is configured to convert the preprocessed analog voice signals into digital signals so as to carry out transmission and processing in a digital system.

In this example, the AI processing module comprises:
a voice identification unit which is configured to identify the digital voice signals transmitted by the voice input module by voice identification algorithm, and convert voice contents into a text form;
a semantic understanding unit which is configured to carry out semantic understanding on the text outputted by the voice identification unit based on a natural language processing technology; and
a learning and decision-making unit which is configured to carry out learning and analysis on behavior patterns of the children by a machine learning model according to use habits and interactive performance of the children.

In this example, the interaction control module comprises:
a process management unit which is responsible for managing the whole use process of the story machine body 1, ensuring that the whole process is orderly carried out according to a predetermined logic from the selection and playing process of the story to the insertion and ending of an interactive link, and providing smooth use experience for the children;
a data coordination unit which is configured to coordinate data transmission and sharing among all the modules; and
an event triggering unit which is configured to monitor events that the NFC story card 17 is inserted, the voice button 16 is pressed and the story is played to a specific part in the use process of the story machine body 1, and trigger the operation of the corresponding module according to the type of the events.

In this example, the power management module comprises:
an electric quantity monitoring unit which is configured to monitor the electric quantity level of the built-in batteries in real time, accurately calculate the percentage of the remaining electric quantity of the batteries by measuring voltage and current parameters of the batteries and applying an electric quantity calculation algorithm, and feed back electric quantity information to other modules, so that a user knows the electric power condition of the story machine body 1 and charges in time;
a charging control unit which is responsible for managing the charging process when the story machine body 1 is connected to an external power supply for charging; and
a power distribution unit which is configured to reasonably distribute the electric power outputted by the batteries according to the electric power requirements of all the modules of the story machine body 1.

The technical solution of the present invention has the following beneficial technical effects:
through question-and-answer link and AI intelligent judgment, the children can actively participate in the development of a story, so that the interactivity can be greatly enhanced; and at a key plot of the story, different answers of the children will lead to different story endings, which makes the children feel own influence on the story, and stimulates the enthusiasm and initiative of the children to participate in;
the AI processing module is capable of carrying out personalized adjustment on the story recommendation and plot trends according to the voice input and interaction performance of the children, and it can provide more challenging stories and questions for the children with high language competence, and provide simpler and more vivid content for young children or children with low language competence, thus meeting the requirements of different children;
the questions in the question-and-answer link can be designed around knowledge points in the story, such as the relationship between characters in the story and the scientific principle, so that in the process of answering the questions, the children cannot only deepen their understanding of the content of the story, but also expand their knowledge and improve their cognitive ability;
because the answers of the children will affect the plots of the story, the children are promoted to think before answering the questions, which develops the logical thinking, creativity and problem-solving skills of the children; and in some open-ended questions, the children need to give play to imagination to conceive the answers, thus exercising their innovative thinking; and
the information of interaction performance and learning progress of the children recorded by the system can provide parents with a basis for knowing the learning and thinking development of the children, and help the parents to carry out targeted education guidance.

Working principle of the present invention:
system initialization: a power management module is started to supply power to each module, and the system will conduct self-inspection to make sure that each hardware module works normally, for example, the display screen 13 normally displays a start picture, and the loudspeaker 14 gives out a prompt tone;
NFC card recognition: when the NFC story card 17 is inserted into the story machine body 1, the NFC identification module will read the card information and transmit data related to the content of the story to a story storage module, and then an interaction control module prepares a corresponding story playing process according to the information of the NFC story card 17;
story display: the story storage module will transmit initial images and text information of the story to a display driving module according to instructions of an interaction control module, the display driving module will drive the display screen 13 to display a story beginning picture, and meanwhile, an audio output module will play an beginning audio of the story;
question-and-answer link triggering: when the story is played to a question-and-answer link, the interaction control module will control the display driving module to display a question on the display screen 13, and a prompt lamp at the voice button 16 will flicker to prompt the children to prepare to answer the question;
voice collection and processing: after the children press the voice button 16, voice will be inputted through the microphone 15, and a voice input module will collect voice signals and transmit digital voice signals to an AI processing module after noise reduction and enhancement preprocessing;
AI analysis and judgment: the AI processing module will analyze the voice inputted by the children through a voice identification algorithm and a natural language understanding algorithm, and judge whether the answer is correct or not; if the answer is correct, a next story scenario branch will be selected according to a preset decision tree algorithm; and if the answer is wrong, a corresponding prompt or guide scenario will be selected;
story plot advancing: according to the judgment result of the AI processing module, the story storage module will select corresponding subsequent content of the story, including audio and image information, and transmit to the audio output module and the display driving module respectively to continuously play the story, and meanwhile, the interaction control module will update interaction records and learning progress information of the children;
ending and feedback: when the story is completely played or other ending conditions (such as actively stopped by the children) are met, the system will conduct summary feedback, the display driving module will display a story summary and interaction performance evaluation of the children on the display screen 13, the audio output module will play corresponding voice feedback, and the power management module will enter a low-power standby mode.

It is to be understood that the foregoing specific embodiments of the present invention are only used for illustrating or explaining the principles of the present invention, and do not constitute a limitation on the present invention. Therefore, any modifications, equivalent replacements, improvements, etc., made without deviating from the spirit and scope of the present invention shall be included in the scope of protection of the present invention. In addition, the claims appended to the present invention are intended to cover all variations and modifications that fall within the scope and boundaries of the appended claims, or in the equivalent form of such scope and boundaries.

1. An AI-based interactive story machine for children, comprising a story machine body (1) and an AI control system, wherein
the story machine body (1) comprises a front housing (11), a rear housing (12), a display screen (13), a loudspeaker (14), a microphone (15), a voice button (16) and an NFC story card (17);
the front housing (11) and the rear housing (12) are connected through a buckle; the display screen (13) is installed in the middle of a side surface of the front housing (11); the loudspeaker (14) and the microphone (15) which are located below the display screen (13) are installed on the side surface of the front housing (11); the voice button (16) is installed on an edge of the side surface of the front housing (11); an inserting opening is formed between top surfaces of the front housing (11) and the rear housing (12), and the NFC story card (17) is inserted into the inserting opening; batteries are installed in the front housing (11) and the rear housing (12); and
the AI control system is configured to implement intelligent interaction and personalized experience of the story machine body (1).

2. The AI-based interactive story machine for children according to claim 1, wherein the AI control system comprises:
a story storage module which is configured to store massive story resources;
an NFC identification module which is responsible for identifying the NFC story card (17) and reading story information in the card and performing related interaction settings, and performing data interaction with the NFC story card (17) through a near-field communication technology;
a display driving module which is configured to drive the display screen (13) to work to display images and text prompts in a story and related information of an interaction link to the children in a visual mode, receive display instructions from other modules, and convert the display instructions into a signal format that can be identified by the display screen (13);
an audio output module which is connected to the loudspeaker (14), and is configured to output audio contents of the story and voice prompts and sound effects in the interaction process, so as to provide auditory experience for the children;
a voice input module which is connected to the microphone (15), and is configured to collect voice answers of the children, and convert the voice answers into digital signals to facilitate subsequent voice identification and processing;
an AI processing module which is responsible for identifying, understanding and analyzing the voice inputted by the children, judging whether the answers of the children are correct or not by a natural language processing algorithm and a machine learning model, and determining the story scenario trends according to an answer result;
an interaction control module which is configured to coordinate interaction work among all the modules of the story machine, manage the story playing process, control the question-and-answer link, and carry out data transmission among the modules; and
a power management module which is configured to manage built-in batteries, comprising battery power monitoring, charging control and stable power supply for other modules;
the story storage module, the NFC identification module, the display driving module, the audio output module, the voice input module, the AI processing module and the interaction control module are all connected to the power management module to obtain power support from the power management module; the NFC identification module is connected to the story storage module so that the read NFC card information can be transmitted to the story storage module to call the story content; the voice input module is connected to the AI processing module so as to transmit the collected voice signals to the AI processing module for analyzing; the AI processing module is connected to the story storage module, the display driving module and the interaction control module to realize story plot selection, image display control and interaction coordination with other modules; the interaction control module is connected to the audio output module and controls the output of story audio and prompt sound effect; and the display driving module is connected to the display screen (13).

3. The AI-based interactive story machine for children according to claim 2, wherein the story storage module comprises:
a storage unit which adopts a built-in mass storage as a physical storage medium, and is responsible for actually storing massive story resources, comprising various types of story data such as fairy tales, fables and science stories, and storing the story data in a digital coding form to provide a data basis for story calling;
an index unit which is configured to establish an index system for the story resources to facilitate quick positioning and retrieval of specific story contents; and
an updating unit which is configured to connect an external data source to realize updating and expansion of the story resources.

4. The AI-based interactive story machine for children according to claim 3, wherein the NFC identification module comprises:
a signal sensing unit which is internally provided with an NFC antenna and a related sensing circuit, and is configured to sense a near-field communication signal transmitted by the NFC story card (17) when the NFC story card (17) approaches, start an identification process, ensure that communication connection is established with the NFC story card (17) and make preparations for data reading;
a data reading unit which is configured to read story information and related interactive setting data from the NFC story card (17) through an NFC communication protocol; and
a compatibility unit which is responsible for ensuring that the NFC identification module is compatible with the NFC story cards (17) with different standards and formats.

5. The AI-based interactive story machine for children according to claim 4, wherein the display driving module comprises:
an image conversion unit which is configured to receive image data from other modules, and convert the image data into a format that can be directly identified and displayed by the display screen (13);
a text rendering unit which is responsible for typesetting and rendering the text prompts and dialogue text information in the story according to characteristics of the display screen; and
an instruction analysis unit which is configured to analyze the display instructions from the interaction control module, and determine the type, display position and display duration parameter of the content to be displayed.

6. The AI-based interactive story machine for children according to claim 5, wherein the audio output module comprises:
a signal amplification unit which is connected to the loudspeaker (14), and is configured to receive audio signals from the story storage module or other modules, and carry out power amplification on the audio signals so as to drive the loudspeaker (14) to generate sound with enough volume, thereby ensuring that the children can clearly hear story contents and sound prompts within a normal use distance, and adapting to volume requirements of different environments;
a sound effect processing unit which is responsible for carrying out sound effect processing on the audio signals; and
an audio mixing unit which is configured to mix the audio signals according to a certain proportion and rule in a case of a plurality of audio sources.

7. The AI-based interactive story machine for children according to claim 6, wherein the voice input module comprises:
a voice collection unit which is connected to the microphone (15) and is configured to carry out preliminary collection on the sound signals received by the microphone (15);
a signal preprocessing unit which is configured to carry out preprocessing operations comprising noise reduction processing on the collected voice signals, remove environmental background noise by a digital signal processing algorithm, and improve the signal-to-noise ratio of the voice signals; and
an analog-to-digital conversion unit which is configured to convert the preprocessed analog voice signals into digital signals so as to carry out transmission and processing in a digital system.

8. The AI-based interactive story machine for children according to claim 7, wherein the AI processing module comprises:
a voice identification unit which is configured to identify the digital voice signals transmitted by the voice input module by voice identification algorithm, and convert voice contents into a text form;
a semantic understanding unit which is configured to carry out semantic understanding on the text outputted by the voice identification unit based on a natural language processing technology; and
a learning and decision-making unit which is configured to carry out learning and analysis on behavior patterns of the children by a machine learning model according to use habits and interactive performance of the children.

9. The AI-based interactive story machine for children according to claim 8, wherein the interaction control module comprises:
a process management unit which is responsible for managing the whole use process of the story machine body (1), ensuring that the whole process is orderly carried out according to a predetermined logic from the selection and playing process of the story to the insertion and ending of an interactive link, and providing smooth use experience for the children;
a data coordination unit which is configured to coordinate data transmission and sharing among all the modules; and
an event triggering unit which is configured to monitor events that the NFC story card (17) is inserted, the voice button (16) is pressed and the story is played to a specific part in the use process of the story machine body (1), and trigger the operation of the corresponding module according to the type of the events.

10. The AI-based interactive story machine for children according to claim 9, wherein the power management module comprises:
an electric quantity monitoring unit which is configured to monitor the electric quantity level of the built-in batteries in real time, accurately calculate the percentage of the remaining electric quantity of the batteries by measuring voltage and current parameters of the batteries and applying an electric quantity calculation algorithm, and feed back electric quantity information to other modules, so that a user knows the electric power condition of the story machine body (1) and charges in time;
a charging control unit which is responsible for managing the charging process when the story machine body (1) is connected to an external power supply for charging; and
a power distribution unit which is configured to reasonably distribute the electric power outputted by the batteries according to the electric power requirements of all the modules of the story machine body (1).
